(19) United States
(12) Patent Application Publication
(10) Pub. No.: US 2014/0372846 A1
(43) Pub. Date: Dec. 18, 2014

(54) READER-CONFIGURABLE AUGMENTATION OF DOCUMENT CONTENT

(71) Applicant: International Business Machines Corporation, Armonk, NY (US)

(72) Inventors: Wendell J. Bouknight, JR., Clayton, NC (US); Erik W. Hochstedt, Holly Springs, NC (US); Thai H. T. La, Raleigh, NC (US); Dana L. Price, Cary, NC (US)

(21) Appl. No.: 13/917,791

(22) Filed: Jun. 14, 2013

(51) Int. Cl. G06F 17/21; G06F 17/22

(52) U.S. Cl. CPC G06F 17/212; G06F 17/2235
USPC 715/205; 715/243

(57) ABSTRACT

Document content is parsed using a reader-defined content creation profile. The document content includes information and information layout specified by an author of the document content. The reader-defined content creation profile specifies document content creation preferences specified by a reader and applicable to augment the document content. A group of individual items of information usable to create augmented document content is identified, as specified by the reader-defined content creation profile, within the parsed document content. A new item of augmented document content is created, as specified by the reader-defined content creation profile, using at least a portion of the identified group of individual items of information. At least the created new item of augmented document content is rendered at a display location specified by the reader-defined content creation profile.

### BACKGROUND

The present invention relates to document content reorganization. More particularly, the present invention relates to reader-configurable augmentation of document content.

Electronic documents may include collections of information, such as a text document generated by a text editor. Electronic documents may also include collections of information, such as calendars, emails with scheduling information for meetings, medical records, social media website entries, notifications on mobile devices (e.g., text messages, news, stock info, etc.), and other forms of electronic documents.

### BRIEF SUMMARY

A method includes parsing, via a processor of a computing device, document content using a reader-defined content creation profile, where the document content comprises information and information layout specified by an author of the document content, and the reader-defined content creation profile specifies document content creation preferences specified by a reader and applicable to augment the document content; identifying within the parsed document content a plurality of individual items of information usable to create augmented document content as specified by the reader-defined content creation profile; creating a new item of augmented document content, as specified by the reader-defined content creation profile, using at least a portion of the identified plurality of individual items of information; and rendering at least the created new item of augmented document content at a display location specified by the reader-defined content creation profile.

A system includes a display, and a processor programmed to: parse document content using a reader-defined content creation profile, where the document content comprises information and information layout specified by an author of the document content, and the reader-defined content creation profile specifies document content creation preferences specified by a reader and applicable to augment the document content; identify within the parsed document content a plurality of individual items of information usable to create augmented document content as specified by the reader-defined content creation profile; create a new item of augmented document content, as specified by the reader-defined content creation profile, using at least a portion of the identified plurality of individual items of information; and render at least the created new item of augmented document content at a display location on the display specified by the reader-defined content creation profile.

A computer program product includes a computer readable storage medium having computer readable program code embodied therewith, where the computer readable program code when executed on a computer causes the computer to: parse document content using a reader-defined content creation profile, where the document content comprises information and information layout specified by an author of the document content, and the reader-defined content creation profile specifies document content creation preferences specified by a reader and applicable to augment the document content; identify within the parsed document content a plurality of individual items of information usable to create augmented document content as specified by the reader-defined content creation profile; create a new item of augmented document content, as specified by the reader-defined content creation profile, using at least a portion of the identified plurality of individual items of information; and render at least the created new item of augmented document content at a display location specified by the reader-defined content creation profile.

### BRIEF DESCRIPTION OF THE SEVERAL VIEWS OF THE DRAWINGS

Figure (FIG.) 1 is a block diagram of an example of an implementation of a system for reader-configurable augmentation of document content according to an embodiment of the present subject matter;

Figure (FIG.) 2 is a block diagram of an example of an implementation of a core processing module capable of performing reader-configurable augmentation of document content according to an embodiment of the present subject matter;

Figure (FIG.) 3 is a diagram of an example of an implementation of original document content that may be processed using reader-defined content creation rules to augment and transform the original document content to a format specified by the user/reader of the document content according to an embodiment of the present subject matter;

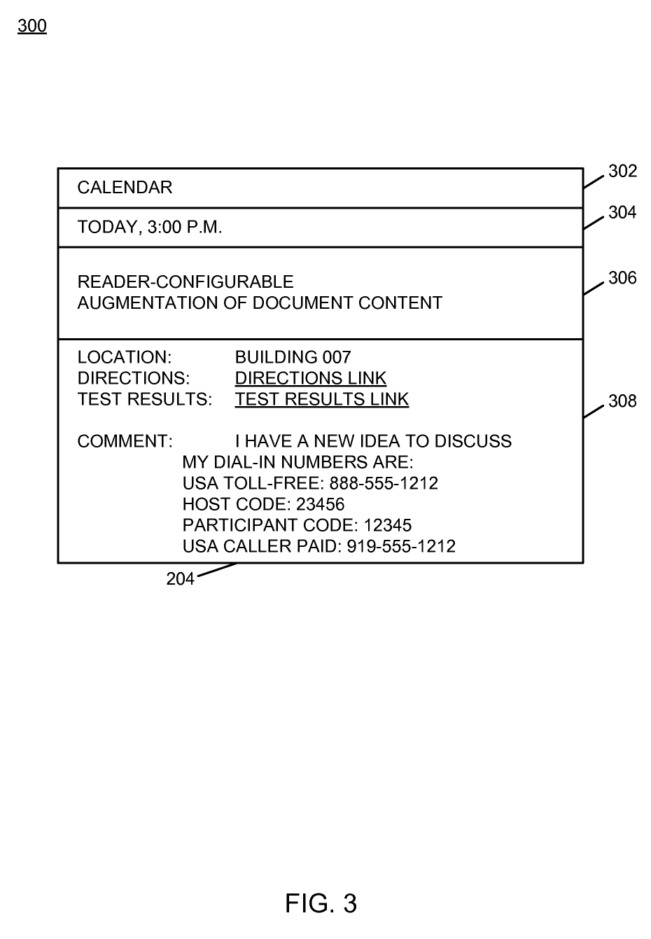

Figure (FIG.) 4 is a diagram of an example of an implementation of transformed document content that has been augmented using the reader-defined content creation rules described in association with FIG. 3 to implement the automated reader-configurable augmentation of document content associated with the present subject matter according to an embodiment of the present subject matter;

Figure (FIG.) 5 is a flow chart of an example of an implementation of a process for reader-configurable augmentation of document content according to an embodiment of the present subject matter;

Figure (FIG.) 6A is a flow chart of an example of an implementation of initial processing within a process for reader-configurable augmentation of document content that includes additional variations of content augmentation processing according to an embodiment of the present subject matter; and

Figure (FIG.) 6B is a flow chart of an example of an implementation of additional processing within a process for reader-configurable augmentation of document content that includes additional variations of content augmentation processing according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides reader-configurable augmentation of document content. Document content of a document to be rendered or stored on an electronic device is parsed using a reader-defined content creation profile. The document content may include information and information layout specified by an author/creator of the document content. The reader-defined content creation profile specifies document content creation preferences specified by a reader of the content and applicable to augment the document content. Individual items of information usable to create augmented document content, as specified by the reader-defined content creation profile, are identified within the document content. At least one new item of augmented document content is created, as specified by the reader-defined content creation profile, using at least a portion of the identified individual items of information. The created new item of augmented document content may be rendered at a display location specified by the reader-defined content creation profile or may be stored for future use. As such, readers may control processing of document content to create new items of content that augment the original content created by the author.

The reader-defined content creation profile may be further configured to include one or more reader-defined device-specific content creation rules. Each of the reader-defined device-specific content creation rules may be configured to create new items of augmented document content that differ based upon a usable display area of each of a number of different devices utilized by the reader. As such, the reader may further control processing of document content based upon which of the multiple electronic devices the user is currently using, and the processing of the document content may be different for each of the user's electronic devices, again as specified based upon preferences of the reader (as opposed to the author's preferences incorporated into the document content at the time of authoring).

The reader-defined content creation profile may further include different reader-defined device-specific content creation rules that are each configured to create new items of augmented document content that differ based upon a content type of the content. The content type may include, for example, a calendar entry content type, an email content type, a medical record content type, a social network entry content type, a notification content type, an instant message content type, a message content type, a news feed content type, and a received data content type. As such, the reader may additionally control processing of document content based upon a type of content being accessed in addition to the electronic device type.

The variety of reader-defined device-specific content creation rules may be configured to be inter-operative or independent, as appropriate for a given implementation. Further, reader-defined device-specific content creation rules may be applied to operate in conjunction with existing applications (e.g., email applications, text messaging applications, etc.), or may be applied prior to providing the content to the respective applications, as configured within the reader-defined content creation profile.

The reader-defined device-specific content creation rules may further specify reorganization of document content to intermingle newly-created augmented content items with individual items of content specified by the user based upon the content identified within the document content. For example, where an author creates content with information of interest to the author, a reader may prefer to filter the author's content to remove information that is not of interest to the reader, or that prevents other information that is of interest to the reader from being displayed if the filtered information is displayed. The filtering and content reorganization options may be based upon the usable display area or other factors as determined by the reader of the document content.

The reader-defined device-specific content creation rules may further be configured to generate notifications for the reader when certain items of content or certain types of items of content are identified within the parsed document content. For example, where a web feed of sports scores are parsed and processed, the scores may be manipulated and only specific pieces of information (e.g., runner batted in (RBI) statistics) may be presented ahead of other information and the user may be notified that the information was identified within the content so the reader may quickly review the information of interest to the reader without being required to review the entire document.

The reader-defined device-specific content creation rules may also be created to be specific to the author/creator of a document. For example, if a specified content author (e.g., friend of the reader) is sending a document, then the reader-defined device-specific content creation rules may process the content differently from a situation where a non-specified content author (e.g., co-worker) is sending a document.

Reader-defined device-specific content creation rules may be configured to be applied to electronic documents based upon an electronic document content type of the respective documents. The reader-defined device-specific content creation rules may specify content augmentation and/or transformation criteria for processing of the document content as specified by the reader of the content. The electronic document content type may include, for example, a calendar document content type for reformatting of calendar entries, a meeting agenda content type for reformatting of meeting agenda content, an email document content type for reformatting of email content, and other document content types as appropriate for a given implementation.

For example, with a calendar entry, a reader-defined device-specific content creation rule may be configured to parse content of the calendar entry to identify a telephone number (e.g., toll-free number if available) and a participant passcode for a conference call. Those two items may be concatenated with a pause character (e.g., “p” or “pc”) when reorganized to form a user-selectable conference call number that allows clickable access to the conference call with programmatic call-in and login to the conference call. As such, the user may access the conference call without having to review the calendar entry to individually identify the various portions of the call-in information and without manual entry of the conference call information to log in to the conference call.

Further, the processing to formulate the user-selectable conference call number may include utilization of a global positioning system (GPS) unit to determine a current location of the computing device and entry of additional information based upon the determined current location. For example, if the user is traveling internationally, an international call prefix may be added to the user-selectable conference call number that is not within the original document content (e.g., prefix “+011” if the conference call is international from the current location). As such, location-aware programmatic dial-in may be implemented to further assist the computing device user.

As another example alternative, where a hypertext link to information or other configuration of information is known to be created that may be navigated to or further processed by a reader or application, more complex types/forms of rules may include multiple steps of processing document content. For example, where document content is generated by a tool as output (e.g., test results during a product development cycle), content may be processed differently to extract particular items of information of interest to the reader and a summary of the content may be created. In such an implementation, when a particular document type is known to create a link to data of interest, identification of the hypertext link within the parsed document content may cause the hypertext link to be navigated and the content of a document accessed and retrieved by navigating the hypertext link. A new item of augmented document content, as specified by a reader-defined content creation profile, may be created by parsing the content of the document accessed by navigating the hypertext link, and a summarized content entry may be created that includes a summary of the retrieved content as specified by the reader-defined content creation profile (e.g., test result summary such as “All tests passed.”).

Additionally, prior to the device displaying the electronic document content, an appropriate reader-defined device-specific content creation rule (based upon the content type and/or device type) may be selected and applied to the electronic document content. The document content may be augmented (e.g., transformed, reorganized, content items omitted, etc.) to be displayed in a new reader-configured client device-specific format as defined by the reader/user.

The present subject matter may be utilized in any electronic document display implementation, though utilization in small display screen device implementations (e.g., portable devices such as smartphones, tablets, etc.) may yield increased benefits based upon the size of the particular display.

As such, many alternatives exist for implementation of the present technology. Accordingly, any such alternative is considered to be within the scope of the present technology.

It should be noted that conception of the present subject matter resulted from recognition of certain limitations associated with document content rendering. For example, it was observed that document formatting is defined by senders or creators of the respective documents. As such, it was observed that when readers/users view content within documents, the displayed content is formatted as defined by the sender or creator of the documents. It was additionally observed that when using a mobile phone with a small display form factor, for example in an agenda view, a single agenda entry may include a large amount of information and, as such, may consume a large amount of available display area. It was determined that the size and quantity of data in such situations makes it difficult for users to see all of the other entries in the agenda. It was additionally determined that such entries often include a considerable amount of information that may not be very useful to the user in that particular view (e.g., other attendees, etc.). It was additionally determined that items of content that may be useful in the mobile environment (e.g., a dial-in phone number and associated passcode for a conference call) are not always accessible in a device-friendly manner and are not configured as a single clickable entry (e.g., random numbers selected for purposes of example: 1-888-555-1212p12345#). It was further determined that different document users may want to utilize document content in different ways or on different devices, but that users of conventional technology are not provided with a way to configure how document content is displayed on their respective individual devices. It was determined that technology to parse document content, and to condense and reformat the content to be displayed in the manner that is most effective for the device and for the individual user's preferences would improve document content usability.

The present subject matter improves document content rendering by providing for reader-configurable augmentation of document content, as described above and in more detail below. As such, improved document content rendering may be obtained through use of the present technology.

The reader-configurable augmentation of document content described herein may be performed in real time to allow prompt reorganization and reformatting of document content. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

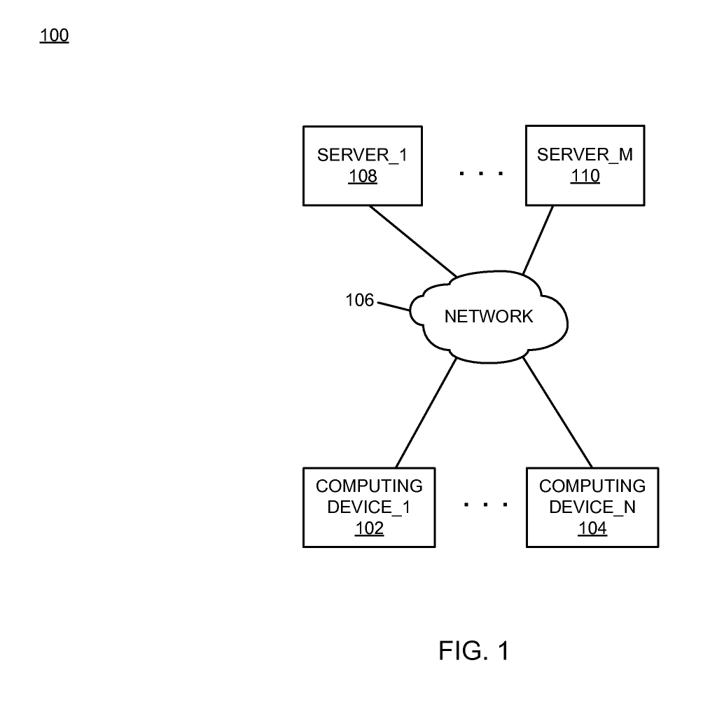

FIG. 1 is a block diagram of an example of an implementation of a system 100 for reader-configurable augmentation of document content. A computing device_{—}1 102 through a computing device_N 104 communicate via a network 106 with several other devices. The other devices include a server_{—}1 108 through a server_M 110. For purposes of the present description the computing device_{—}1 102 through the computing device_N 104 may be considered client devices and may execute one or more applications that may be stand-alone applications or client-server-based applications. Additionally, the server_{—}1 108 through the server_M 110 may be considered information servers or server-based application servers.

Users of the computing device_{—}1 102 through the computing device_N 104 may send messages (e.g., email, text messages, calendar appointments, etc.) to each other via the network 106 and/or one or more of the server_{—}1 108 through the server_M 110. One or more of the server_{—}1 108 through the server_M 110 may also host/store documents or websites that include content. As described above, message content and other forms of documents/information may be processed using the technology described herein to reorganize and/or reformat the content based upon user preferences that may themselves be customized for a display screen form factor of each particular computing device (e.g., smartphone, tablet, etc.).

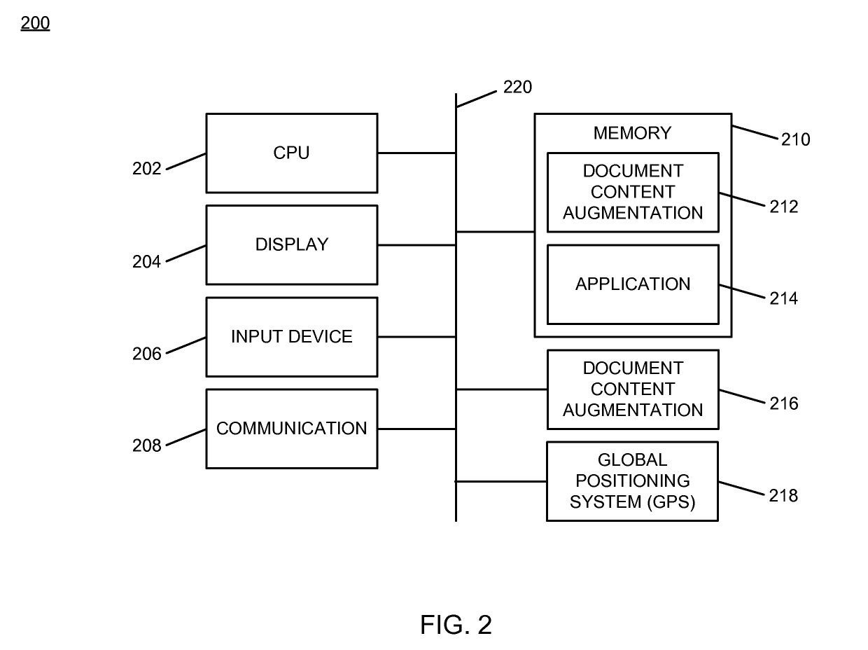

As will be described in more detail below in association with FIG. 2 through FIG. 6B, the computing device_{—}1 102 through the computing device_N 104 may each provide automated reader-configurable augmentation of document content. Alternatively and/or additionally, the server_{—}1 108 through the server_M 110 may provide automated reader-configurable augmentation of document content and deliver reformatted content to the respective computing devices 102 through 104. As such, the present technology may be implemented at a user computing device or server device level.

The automated reader-configurable augmentation of document content is based upon reformatting and reorganization of document content using reader-defined content creation rules that specify individualized reformatting of document content tailored to each particular computing device for which the user has configured document content augmentation and reformatting. As such, the user may define different augmentation, reformatting, and reorganization of document content within one or more content display reformatting rules for each of a variety of user-interface-based computing devices used by the user. The user may then be presented with a customized and individualized presentation of document content that is different for each computing device used by the user. The individualized presentation of document content may be specified by the user to utilize available screen display area in a manner conducive to ease of content viewing by the user and, as such, may be individualized to omit portions of content that would otherwise consume display area. Further, new items of content may be created that provide increased utility for the reader of the content, such as user selectable/clickable auto-dial numbers for conference calls and content summaries, or other new content items as appropriate for the given implementation. As such, a variety of possibilities exist for implementation of the present subject matter, and all such possibilities are considered within the scope of the present subject matter.

It should be noted that any of the respective computing devices described in association with FIG. 1 may be portable computing devices, either by a user's ability to move the respective computing devices to different locations, or by the respective computing device's association with a portable platform, such as a plane, train, automobile, or other moving vehicle. It should also be noted that the respective computing devices may be any computing devices capable of processing information as described above and in more detail below. For example, the respective computing devices may include devices such as a personal computer (e.g., desktop, laptop, etc.) or a handheld device (e.g., cellular telephone, personal digital assistant (PDA), email device, music recording or playback device, tablet computing device, e-book reading device, etc.), a web server, application server, or other data server device, or any other device capable of processing information as described above and in more detail below.

The network 106 may include any form of interconnection suitable for the intended purpose, including a private or public network such as an intranet or the Internet, respectively, direct inter-module interconnection, dial-up, wireless, or any other interconnection mechanism capable of interconnecting the respective devices.

The server_{—}1 108 through the server_M 110 may include any device capable of providing data for consumption by a device, such as the computing device_{—}1 102 through the computing device_N 104, via a network, such as the network 106. As such, the server_{—}1 108 through the server_M 110 may each include a web server, application server, email server, text message server, calendar server, or other data server device. The respective server_{—}1 108 through the server_M 110 may also incorporate or utilize one or more databases (not shown) or other storage devices for retrieval of document content.

FIG. 2 is a block diagram of an example of an implementation of a core processing module 200 capable of performing reader-configurable augmentation of document content. The core processing module 200 may be associated with either the computing device_{—}1 102 through the computing device_N 104 or with the server_{—}1 108 through the server_M 110, as appropriate for a given implementation. As such, the core processing module 200 is described generally herein, though it is understood that many variations on implementation of the components within the core processing module 200 are possible and all such variations are within the scope of the present subject matter.

Further, the core processing module 200 may provide different and complementary processing for augmentation of document content in association with each implementation. As such, for any of the examples below, it is understood that any aspect of functionality described with respect to any one device that is described in conjunction with another device (e.g., sends/sending, etc.) is to be understood to concurrently describe the functionality of the other respective device (e.g., receives/receiving, etc.).

A central processing unit (CPU) 202 provides computer instruction execution, computation, and other capabilities within the core processing module 200. A display 204 provides visual information to a user of the core processing module 200 and an input device 206 provides input capabilities for the user.

The display 204 may include any display device, such as a cathode ray tube (CRT), liquid crystal display (LCD), light emitting diode (LED), electronic ink displays, projection, touchscreen, or other display element or panel. The input device 206 may include a computer keyboard, a keypad, a mouse, a pen, a joystick, touchscreen, or any other type of input device by which the user may interact with and respond to information on the display 204.

A communication module 208 provides interconnection capabilities that allow the core processing module 200 to communicate with other modules within the system 100. The communication module 208 may include any electrical, protocol, and protocol conversion capabilities useable to provide interconnection capabilities, appropriate for a given implementation.

A memory 210 includes a document content augmentation storage area 212 that stores original documents/document content that may be augmented, reformatted, and reorganized as described herein. The document content augmentation storage area 212 also stores augmented, reformatted, and reorganized document content that has been processed as described herein to individualize the display of the document content for individual computing devices as specified by the user within reader-defined content transformation rules.

The memory 210 also includes an application area 214 that provides storage and execution space for one or more applications. The applications may include locally executed applications or local interface applications (e.g., client applications) for remotely executed applications (server applications). The applications may include text editors, email applications, text messaging applications, calendaring or meeting agenda applications, or other applications as appropriate for a given implementation. As described above and in more detail below, document content processed by the respective applications may be augmented/reformatted/reorganized using reader-defined content creation rules that operate in conjunction with the applications to modify rendering of original document content as specified by the user(s) within the reader-defined content creation rules.

It is understood that the memory 210 may include any combination of volatile and non-volatile memory suitable for the intended purpose, distributed or localized as appropriate, and may include other memory segments not illustrated within the present example for ease of illustration purposes. For example, the memory 210 may include a code storage area, an operating system storage area, a code execution area, and a data area without departure from the scope of the present subject matter.

A document content augmentation module 216 is also illustrated. The document content augmentation module 216 provides processing capabilities for the creation of reader-defined content creation rules and for augmenting document content using created reader-defined content creation rules for the core processing module 200, as described above and in more detail below. The document content augmentation module 216 implements the automated reader-configurable augmentation of document content of the core processing module 200.

It should also be noted that the document content augmentation module 216 may form a portion of other circuitry described without departure from the scope of the present subject matter. Further, the document content augmentation module 216 may alternatively be implemented as an application stored within the memory 210. In such an implementation, the document content augmentation module 216 may include instructions executed by the CPU 202 for performing the functionality described herein. The CPU 202 may execute these instructions to provide the processing capabilities described above and in more detail below for the core processing module 200. The document content augmentation module 216 may form a portion of an interrupt service routine (ISR), a portion of an operating system, a portion of a browser application, or a portion of a separate application without departure from the scope of the present subject matter.

A global positioning system (GPS) module 218 provides positioning location coordinates usable for identifying a current location of a computing device. The GPS module 218 may also be used to identify physical and/or logical location information usable by the document content augmentation module 216 for adding prefixes (e.g., international calling prefixes) or other information to user-selectable conference call numbers, or for other purposes as appropriate for a given implementation.

The CPU 202, the display 204, the input device 206, the communication module 208, the memory 210, the document content augmentation module 216, and the GPS module 218 are interconnected via an interconnection 220. The interconnection 220 may include a system bus, a network, or any other interconnection capable of providing the respective components with suitable interconnection for the respective purpose.

Though the different modules illustrated within FIG. 2 are illustrated as component-level modules for ease of illustration and description purposes, it should be noted that these modules may include any hardware, programmed processor(s), and memory used to carry out the functions of the respective modules as described above and in more detail below. For example, the modules may include additional controller circuitry in the form of application specific integrated circuits (ASICs), processors, antennas, and/or discrete integrated circuits and components for performing communication and electrical control activities associated with the respective modules. Additionally, the modules may include interrupt-level, stack-level, and application-level modules as appropriate. Furthermore, the modules may include any memory components used for storage, execution, and data processing for performing processing activities associated with the respective modules. The modules may also form a portion of other circuitry described or may be combined without departure from the scope of the present subject matter.

Additionally, while the core processing module 200 is illustrated with and has certain components described, other modules and components may be associated with the core processing module 200 without departure from the scope of the present subject matter. Additionally, it should be noted that, while the core processing module 200 is described as a single device for ease of illustration purposes, the components within the core processing module 200 may be co-located or distributed and interconnected via a network without departure from the scope of the present subject matter. For a distributed arrangement, the display 204 and the input device 206 may be located at a point of sale device, kiosk, or other location, while the CPU 202 and memory 210 may be located at a local or remote server. Many other possible arrangements for components of the core processing module 200 are possible and all are considered within the scope of the present subject matter. Accordingly, the core processing module 200 may take many forms and may be associated with many platforms.

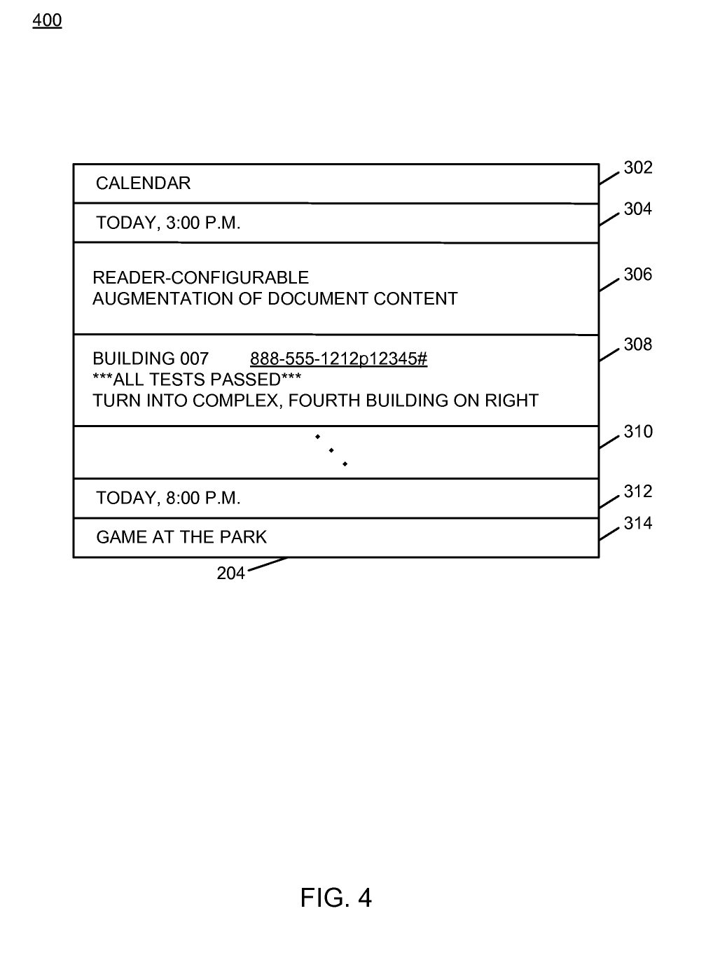

FIG. 3 through FIG. 4 described below represent example document content that may be rendered by devices, such as the core processing module 200, using the reader-configurable augmentation of document content described herein. FIG. 3 through FIG. 4 represent an example sequence of processing to implement the reader-configurable augmentation of document content associated with the present subject matter.

FIG. 3 is a diagram of an example of an implementation of original document content 300 that may be processed using reader-defined content creation rules to augment and transform the original document content 300 to a format specified by the user/reader of the document content. The display 204 is shown to be displaying an entry of a calendar application for a meeting. For purposes of the present example, it is assumed that the display 204 is a display device associated with a smartphone and that there is limited display area for display of the entry of the calendar application for the meeting.

The entry of the calendar application for the meeting includes a title bar 302, a calendar entry date/time field 304, an event title field 306, and a calendar entry information field 308. The calendar entry information field 308 is considered to have been populated by a meeting organizer (author) of the scheduled meeting and includes information determined by the meeting organizer. As described above, a user of the present technology may create one or more reader-defined content transformation rules that govern and control reformatting of document content, such as the original document content 300 of the entry of the calendar application shown within FIG. 3. As such, while the meeting organizer included information appropriate for the meeting organizer's purposes, the user of the present technology may initiate reformatting of the document content that is appropriate for the user's/reader's purposes (as opposed to the author's preferences).

For example, as can be seen within FIG. 3, the calendar entry information field 308 includes a “Location” field, a “Directions” field that includes a hypertext link “Directions Link,” a “Test Results” field that includes a hypertext link “Test Results Link,” and a “Comment” field that includes a personal comment from the meeting organizer (e.g., “I have an idea to discuss”) and several items of dial-in conference call information.

For purposes of the present example, it is assumed that the “Directions Link” is navigable to a web site that provides directions based upon at least a destination of the meeting. Further, a current location of the computing device (as determined by GPS) may be used as a start location for the directions and passed to the web site when the link is navigated. Additionally, it is assumed that the “Test Results Link” is navigable to a web site that provides a document that includes individual test results (e.g., “Test 1: passed,” “Test 2: passed,” etc.).

It is further assumed that the recipient of this document content has specified one or more reader-defined content creation rules that control reformatting of document content within the entry of the calendar application. It is further assumed that the one or more reader-defined content creation rules provide formatting for at least the smartphone for which the display 204 is associated for purposes of the present example. However, it should be noted that reader-defined content creation rules may specify different reader-defined creation rules for augmentation and reformatting of document content for each of several computing devices and for each of several applications utilized by the user. As such, the document content may be reformatted differently, as specified and configured by the user, for display using the available display area specific to each such computing device.

Continuing with the present example, the one or more reader-defined content creation profiles associated with the present example include three distinct content creation rules. As a first reader-defined content creation rule, field identifiers are to be removed (e.g., remove “Location,” “Directions,” “Test Results,” and “Comment” field identifiers).

As a second reader-defined content creation rule, several content augmentation and reformatting operations are specified by the user to be performed. As a first operation, the document content (e.g., the “Comment” field) is to be parsed to identify the most cost-effective telephone number to use for the call (e.g., a toll-free number or local number preferred over long-distance numbers) and parsed to identify the participant access code for the conference call. As a second operation, a concatenated reader-selectable clickable dial-in number for the conference call is to be created. The reader-selectable clickable dial-in number for the conference call is specified by the reader to include the identified telephone number appended/concatenated with a pause character (e.g., “p”), which is further appended/concatenated with the identified participant access code, which is further appended/concatenated with a system-specific entry code that causes entry of the participant access code within the conference call system (e.g., a pound symbol (“#”)). A symbol such as the pound symbol may be used by certain systems to complete a login to a conference call as an enter character for a conference call passcode (e.g., participant or host access codes). As a third operation, the concatenated string sequence is to be configured/converted into a user-selectable (e.g., clickable) dial-in number and to cause an integrated programmatic dial-in and login to the conference call. It should be noted that the user-selectable dial-in number to log into the conference call constitutes a new data item that did not exist within the original document content, but was created from the document content by parsing the document content, identification of usable data entries, manipulation of the data entries to form the string sequence, and conversion of the string sequence into the user-selectable dial-in number.

As a fourth operation, any hypertext link to obtain directions to a meeting or other location is to be navigated and the directions retrieved and displayed instead of the hypertext link. The retrieved directions may also be processed/transformed as specified by the user in the reader-defined content transformation rule, as appropriate for a given implementation. As a fifth operation, the reformatted and/or obtained content (e.g., directions via the hypertext link) are to be reformatted and displayed with the location displayed below the user-selectable dial-in number to log into the conference call, with the directions retrieved via the hypertext link displayed as in-line text below location and the user-selectable dial-in number. As a sixth operation, any hypertext link to test results is to be navigated and a summary of the test results is to be created and displayed above any directions to the conference call location. As a seventh operation, any other information is to be omitted from the displayed calendar entry.

FIG. 4 is a diagram of an example of an implementation of transformed document content 400 that has been augmented using the reader-defined content creation rules described in association with FIG. 3 to implement the automated reader-configurable augmentation of document content associated with the present subject matter. As can be seen from FIG. 4, the calendar entry information field 308 has been programmatically reformatted using the reader-defined content creation rules described above in association with FIG. 3.

As such, the field identifiers (e.g., “Location,” “Directions,” and “Comment” field identifiers) have been removed. Additionally, the calendar entry information field 308 displays the location of the meeting beside the user-selectable dial-in number to log in to the conference call. As described above, the user-selectable (e.g., clickable) dial-in number to log in to the conference call constitutes a new data item that did not exist in isolation within the original document content, but was created from the document content by parsing the document content, identifying usable data entries, manipulating the data entries to form the string sequence, and converting the string sequence into the user-selectable dial-in number.

Additionally, the hypertext link for the directions to the meeting has been navigated, the directions have been retrieved, and a truncated/summarized version of the retrieved directions has been created. The truncated/summarized version of the retrieved directions has been displayed in-line within the calendar entry information field 308 below the location and user-selectable dial-in number. As such, the user may either travel to the meeting location using the directions for the trip, or may conference into the meeting via a single selection using the newly-created user-selectable dial-in number. Further, if the participant is traveling to attend the meeting, but is delayed, the user may instead call in using the newly-created user-selectable dial-in number.

Further, the hypertext link for the test results has been navigated and the test results have been retrieved, the retrieved test results have been parsed, and a summary of the test results has been created. The created summary of the test results further reformats the content display to cause the summary of the test results to be displayed in-line within the calendar entry information field 308 above the location of the concatenated driving directions. Within the present example, it is shown that “***All Tests Passed***,” though it is noted that for purposes of the present example the leading and trailing asterisks were specified within a reader-defined content creation rule to further augment the created summary of the test results retrieved by navigating the hypertext link to the test results.

As such, a variety of content augmentation operations are possible using the present technology and each may be granularly applied to create, reformat, and reorganize content as specified by the reader of the content. Accordingly, readers of content may control many aspects of content rendering independently of the organization and format specified by authors of the content.

As an additional observation, the calendar entry information field 308 within the transformed document content 400 consumes much less display area on the display 204 compared to the calendar entry information field 308 within the original document content 300 provided by the meeting organizer. The reduced display area of the calendar entry information field 308 allows an additional calendar entry spacer 310 and an additional calendar entry including a calendar entry date/time field 312 and a calendar entry information field 314 to be displayed contemporaneously with the previously-described calendar entry. It should be noted that the calendar entry spacer 310 is utilized within the present example to assist with description and visual spacing of the drawing figure and may be omitted as appropriate for the given implementation. As such and as described above, display area utilization at the discretion and control of the user may be improved, and the user may look forward to other events without having to scroll or otherwise manipulate the calendar application.

Accordingly, using the present technology, the user/reader may control the display properties of the calendar entry information field 308 including what information is displayed, where the displayed information is displayed, in-line replacement of hypertext links with data/information concatenations and/or summaries of content stored in association with traversal of the hypertext links, and creation of new data items based upon parsed data from the original document content to increase efficiency for the user. Many other example uses of the present technology exist, and all such examples are considered within the scope of the present technology.

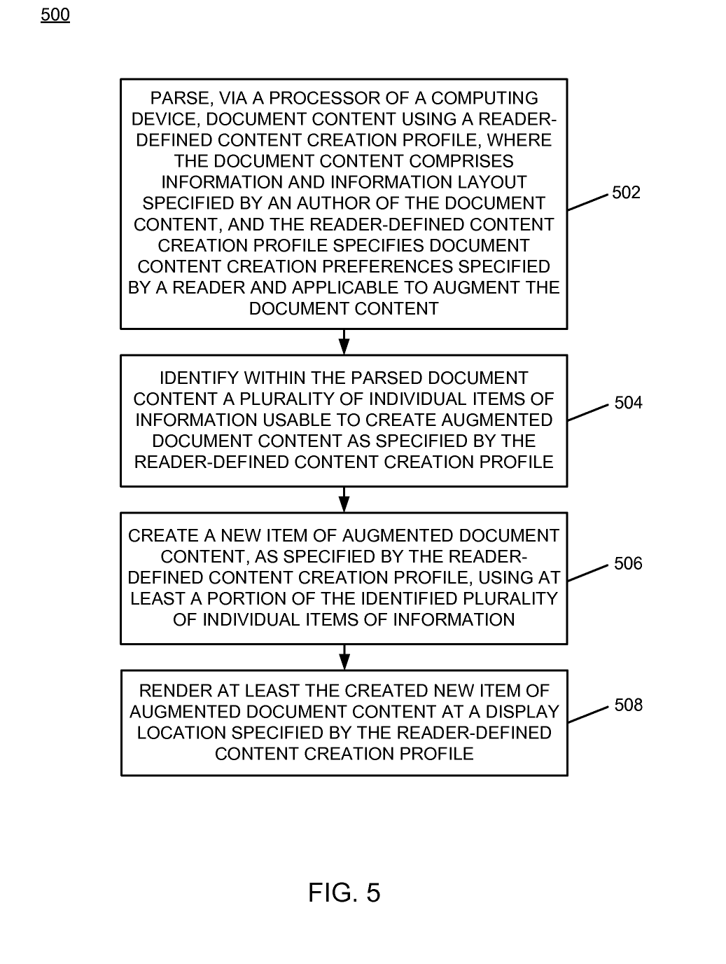

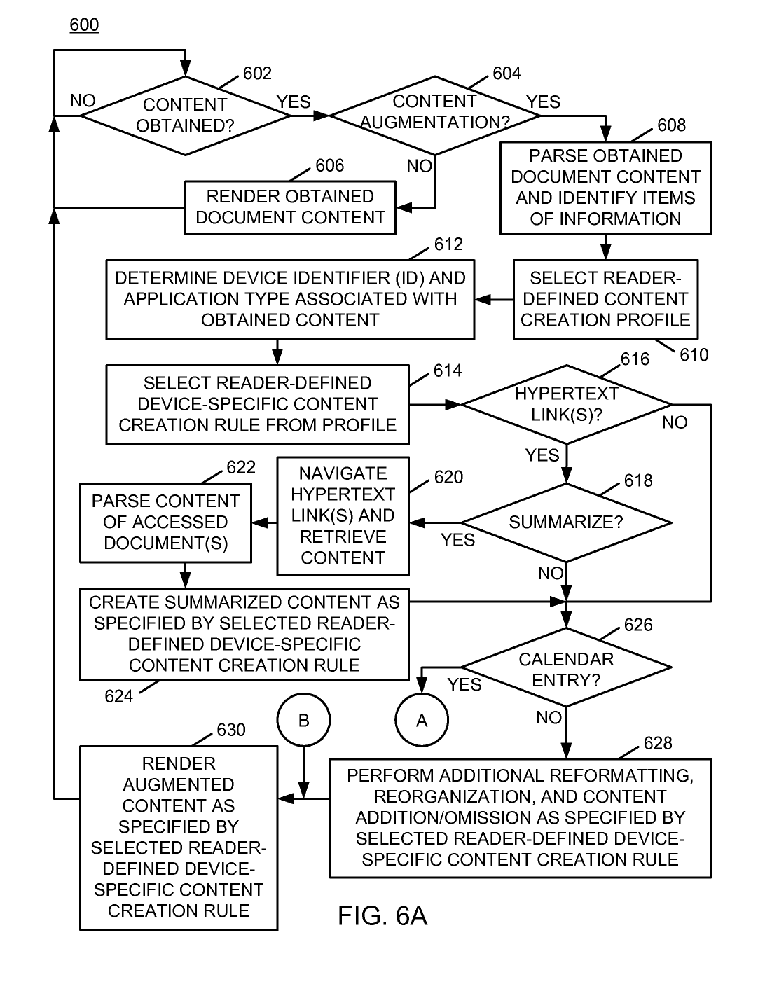

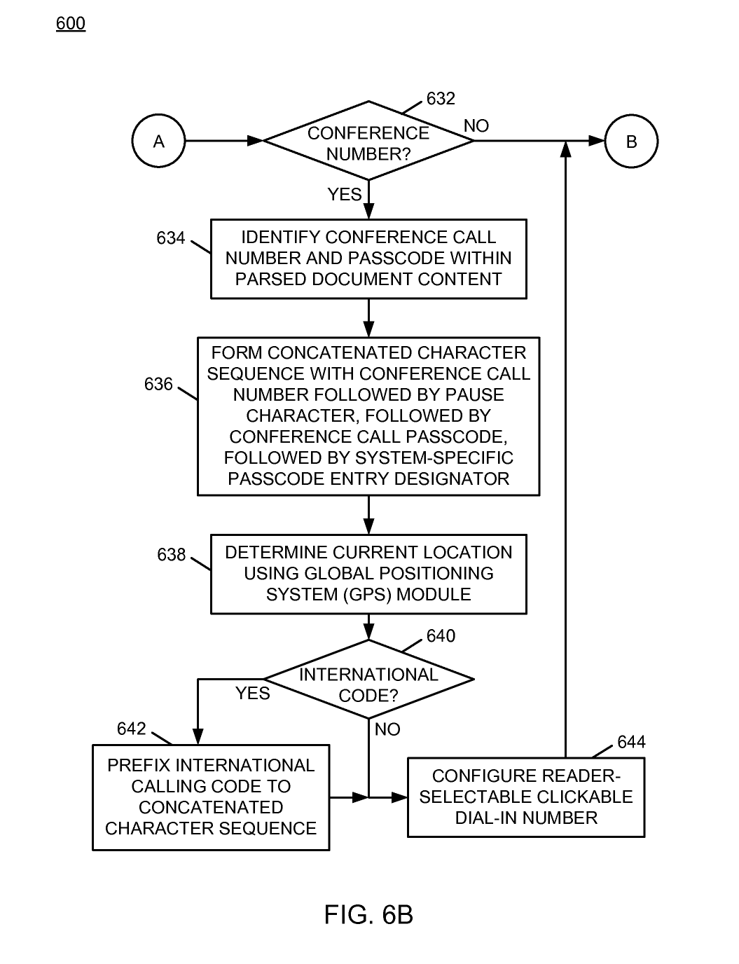

FIG. 5 through FIG. 6B described below represent example processes that may be executed by devices, such as the core processing module 200, to perform the automated reader-configurable augmentation of document content associated with the present subject matter. Many other variations on the example processes are possible and all are considered within the scope of the present subject matter. The example processes may be performed by modules, such as the document content augmentation module 216 and/or executed by the CPU 202, associated with such devices. It should be noted that time out procedures and other error control procedures are not illustrated within the example processes described below for ease of illustration purposes. However, it is understood that all such procedures are considered to be within the scope of the present subject matter. Further, the described processes may be combined, sequences of the processing described may be changed, and additional processing may be added or removed without departure from the scope of the present subject matter.

FIG. 5 is a flow chart of an example of an implementation of a process 500 for reader-configurable augmentation of document content. At block 502, the process 500 parses, via a processor of a computing device, document content using a reader-defined content creation profile, where the document content comprises information and information layout specified by an author of the document content, and the reader-defined content creation profile specifies document content creation preferences specified by a reader and applicable to augment the document content. At block 504, the process 500 identifies within the parsed document content a plurality of individual items of information usable to create augmented document content as specified by the reader-defined content creation profile. At block 506, the process 500 creates a new item of augmented document content, as specified by the reader-defined content creation profile, using at least a portion of the identified plurality of individual items of information. At block 508, the process 500 renders at least the created new item of augmented document content at a display location specified by the reader-defined content creation profile.

FIGS. 6A-6B illustrate a flow chart of an example of an implementation of process 600 for reader-configurable augmentation of document content that includes additional variations of content augmentation processing. FIG. 6A illustrates initial processing within the process 600. At decision point 602, the process 600 makes a determination as to whether document content has been obtained for processing, such as by receipt of a message (e.g., text, email, calendar entry, etc.) or document content being read from a memory. In response to determining that document content has been obtained for processing, the process 600 makes a determination at decision point 604 as to whether to augment the obtained document content. For example, document content augmentation may be applied based upon a content type or application type. Further, as described above and in more detail below, the document content augmentation may be applied as configured within a reader-defined content creation profile. In response to determining not to augment the obtained document content at decision point 604, the process 600 renders the obtained document content at block 606. The process 600 returns to decision point 602 and iterates as described above.

Returning to the description of decision point 604, in response to determining to augment the obtained document content, the process 600 parses the obtained document content using a reader-defined content creation profile and identifies individual items of information usable to create augmented document content at block 608. As described above, the document content may include information and information layout specified by an author of the document content. Further, a reader-defined content creation profile may be configured to specify document content creation preferences specified by a reader and applicable to augment the document content.

At block 610, the process 600 selects a reader-defined content creation profile to use to augment the obtained document content using the identified individual items of information from the document content. At block 612, the process 600 determines a device identifier (ID) and application type associated with the obtained document content.

For purposes of the present example, it is assumed that the user/reader has several configured devices for which content augmentation may be performed, and that the user has configured several different reader-defined device-specific content creation rules within the selected reader-defined content creation profile. Additionally, each of the reader-defined device-specific content creation rules is configured to create new items of augmented document content differently based upon a usable display area of each of a plurality of different devices utilized by the reader. Further, the reader-defined device-specific content creation rules may be configured to create new items of augmented document content differently based upon a content type/application type, such as calendar entry content and/or application type, an email content and/or application type, a medical record content and/or application type, a social network entry content and/or application type, a notification content and/or application type, an instant message content and/or application type, a message content and/or application type, a news feed content and/or application type, and a received data content and/or application type.

It is additionally assumed for purposes of the present example, that the current device is a smartphone with an identifier usable to select a reader-defined device-specific content creation rule from the selected reader-defined content creation profile. Further, for purposes of the present example, it is assumed that the application type is a calendar application and that the document content is at least one calendar entry, and that this information may further be used to refine selection of a reader-defined device-specific content creation rule. It should be noted that other variations of devices and application types are possible and all such possibilities are considered within the scope of the present subject matter and examples. At block 614, the process 600 selects a reader-defined device-specific content creation rule from the selected reader-defined content creation profile using at least one of the determined device identifier (ID) and application type associated with the obtained document content.

At decision point 616, the process 600 makes a determination as to whether one or more hypertext links are included within the document content. It is understood that the processing described below may be performed for each identified hypertext link within the document content, and that the process 600 is considered to include processing of each identified hypertext link. Processing associated with a negative determination at decision point 616 will be deferred and described in more detail below.

In response to determining that at least one hypertext link has been identified within the document content at decision point 616, the process 600 makes a determination for each hypertext link as to whether to navigate to and summarize additional content accessible via each identified hypertext link at decision point 618. In response to determining for any identified hypertext link to navigate to and summarize the additional content accessible via the respective hypertext link, the process 600 navigates to the respective hypertext link(s) and retrieves the additional content at block 620. At block 622, the process 600 parses the additional content of the accessed document(s). At block 624, the process 600 creates a summarized content entry including a summary of the retrieved content as specified by one of the selected reader-defined device-specific content creation rule or the selected reader-defined content creation profile, as appropriate for the given implementation.

In response to creating the summarized content entry at block 624, or in response to determining at decision point 618 not to navigate to and summarize additional content accessible via each identified hypertext link, or in response to determining at decision point 616 that at least one hypertext link has not been identified within the document content, the process 600 makes a determination at decision point 626 as to whether the document content is a calendar entry. Processing associated with an affirmative determination at decision point 626 will be deferred and described in more detail below.

As such, in response to determining at decision point 626 that the document content is not a calendar entry, the process 600 performs any additional reformatting, reorganization, and content addition/omission as specified by the selected reader-defined device-specific content creation rule at block 628. Reference to the description of FIG. 3 and FIG. 4 above provides examples of certain reformatting, reorganization, and content addition/omission options that may be specified by the user/reader of the document content, though it is understood that additional options are possible and all such options are considered within the scope of the present subject matter.

At block 630, the process 600 renders the augmented document content as specified by the selected reader-defined device-specific content creation rule. The process 600 returns to decision point 602 and iterates as described above.

Returning to the description of decision point 626, in response to determining that the document content is a calendar entry, the process 600 transitions to the processing shown and described in association with FIG. 6B.

FIG. 6B illustrates additional processing associated with the process 600 for reader-configurable augmentation of document content that includes additional variations of content augmentation processing. At block 632, the process 600 makes a determination as to whether a conference call telephone number has been identified within the parsed document content. In response to determining that a conference call telephone number has not been identified within the parsed document content, the process 600 returns to the processing described above in association with FIG. 6A at block 630 and iterates as described above.

In response to determining at decision point 632 that a conference call telephone number has been identified within the parsed document content, the process 600 identifies a conference call telephone number of a conference call and a conference call passcode within the parsed document content at block 634. At block 636, the process 600 forms a concatenated character sequence comprising the identified conference call telephone number, followed by a telephone dialing pause character (e.g., “p,” etc.), followed by the identified conference call passcode, and followed by a system-specific passcode entry designator (e.g., a pound character “#,” etc.).

At block 638, the process 600 determines a current location of the reader's computing device (e.g., smartphone for purposes of the present example) using a global positioning system (GPS) module, such as the GPS module 218 described above. At decision point 640, the process 600 makes a determination, based upon the current location of the computing device, as to whether telephone system access to the conference call telephone number utilizes an international calling code. In response to determining, based upon the current location of the computing device, that telephone system access to the conference call telephone number utilizes an international calling code, at block 642 the process 600 prefixes an appropriate international calling code to the concatenated character sequence formed as described above.

In response to prefixing, at block 642, the appropriate international calling code to the concatenated character sequence formed as described above, or in response to determining at decision point 640 that telephone system access to the conference call telephone number does not utilize an international calling code, the process 600 configures a reader-selectable clickable dial-in number using the concatenated character sequence formed as described above, either with or without the international calling code, at block 644. The process 600 returns to the processing described above in association with FIG. 6A at block 630 and iterates as described above. It should be noted that while the present example within FIGS. 6A and 6B does not show processing for reader selection of the configured reader-selectable clickable dial-in number, this is considered to be a portion of the process 600.

As such, the process 600 obtains and parses obtained document content and creates new and/or augmented items of content using a reader-defined content creation profile and identified individual items of content entered and formatted by the author of the content. The process 600 traverses and summarizes hypertext links to improve reader efficiency and use of small form factor devices. The process 600 also creates a reader-selectable clickable dial-in number as another example of implementation of the present technology. Accordingly, readers of content may control what content is rendered based upon the respective devices they utilize to render and read the content, and may control augmentation of the author's content as appropriate based upon user preferences that may be specified in one or more reader-defined device-specific content creation rules, that may also be associated with a reader-defined content creation profile.

As described above in association with FIG. 1 through FIG. 6B, the example systems and processes provide reader-configurable augmentation of document content. Many other variations and additional activities associated with reader-configurable augmentation of document content are possible and all are considered within the scope of the present subject matter.

Those skilled in the art will recognize, upon consideration of the above teachings, that certain of the above examples are based upon use of a programmed processor, such as the CPU 202. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
parsing, via a processor of a computing device, document content using a reader-defined content creation profile, where the document content comprises information and information layout specified by an author of the document content, and the reader-defined content creation profile specifies document content creation preferences specified by a reader and applicable to augment the document content;
identifying within the parsed document content a plurality of individual items of information usable to create augmented document content as specified by the reader-defined content creation profile;
creating a new item of augmented document content, as specified by the reader-defined content creation profile, using at least a portion of the identified plurality of individual items of information; and
rendering at least the created new item of augmented document content at a display location specified by the reader-defined content creation profile.

2. The method of claim 1, where:
the document content comprises a calendar entry;
identifying within the parsed document content the plurality of individual items of information usable to create the augmented document content as specified by the reader-defined content creation profile comprises:
identifying a conference call telephone number of a conference call within the parsed document content; and
identifying a conference call passcode within the parsed document content; and
creating the new item of augmented document content, as specified by the reader-defined content creation profile, using at least the portion of the identified plurality of individual items of information comprises:
creating a reader-selectable clickable dial-in number for the conference call that causes programmatic dial-in and login to the conference call in response to reader selection of the reader-selectable clickable dial-in number.

3. The method of claim 2, where creating the reader-selectable clickable dial-in number for the conference call that causes programmatic dial-in and login to the conference call in response to reader selection of the reader-selectable clickable dial-in number comprises:
forming a concatenated character sequence comprising the conference call telephone number, followed by a telephone dialing pause character, followed by the conference call passcode, and followed by a system-specific passcode entry designator; and
configuring the reader-selectable clickable dial-in number using the concatenated character sequence.

4. The method of claim 3, further comprising:
determining a current location of the computing device using a global positioning system (GPS) module;
determining, based upon the current location of the computing device, that telephone system access to the conference call telephone number utilizes an international calling code; and
where forming the concatenated character sequence comprises:
prefixing the international calling code to the concatenated character sequence comprising the conference call telephone number, followed by the telephone dialing pause character, followed by the conference call passcode, and followed by the system-specific participant access code entry designator.

5. The method of claim 1, where, in response to detection of a hypertext link within the document content, the reader-defined content creation profile specifies creation of a summarized content entry using accessible content of the hypertext link, and further comprising:
identifying the hypertext link within the parsed document content;
navigating the hypertext link; and
retrieving content of a document accessed by navigating the hypertext link; and
where:
creating the new item of augmented document content, as specified by the reader-defined content creation profile, using at least the portion of the identified plurality of individual items of information comprises:
parsing the content of the document accessed by navigating the hypertext link; and
creating the summarized content entry comprising a summary of the retrieved content as specified by the reader-defined content creation profile.

6. The method of claim 1, where the reader-defined content creation profile comprises a plurality of reader-defined device-specific content creation rules, each of the plurality of reader-defined device-specific content creation rules configured to create new items of augmented document content differently based upon a usable display area of each of a plurality of different devices utilized by the reader, and further comprising:
determining an identifier of the computing device; and
selecting a reader-defined device-specific content creation rule from the reader-defined content creation profile based upon the identifier of the computing device; and
where creating the new item of augmented document content, as specified by the reader-defined content creation profile, using at least the portion of the identified plurality of individual items of information comprises:
creating the new item of augmented document content, as specified by the selected reader-defined device-specific content creation rule, using at least the portion of the identified plurality of individual items of information.

7. The method of claim 1, where the reader-defined content creation profile comprises a plurality of reader-defined device-specific content creation rules, each of the plurality of reader-defined device-specific content creation rules configured to create new items of augmented document content differently based upon a content type selected from a group consisting of a calendar entry content type, an email content type, a medical record content type, a social network entry content type, a notification content type, an instant message content type, a message content type, a news feed content type, and a received data content type.

8. A system, comprising:
a display; and
a processor of a computing device programmed to:
parse document content using a reader-defined content creation profile, where the document content comprises information and information layout specified by an author of the document content, and the reader-defined content creation profile specifies document content creation preferences specified by a reader and applicable to augment the document content;
identify within the parsed document content a plurality of individual items of information usable to create augmented document content as specified by the reader-defined content creation profile;
create a new item of augmented document content, as specified by the reader-defined content creation profile, using at least a portion of the identified plurality of individual items of information; and
render at least the created new item of augmented document content at a display location on the display specified by the reader-defined content creation profile.

9. The system of claim 8, where:
the document content comprises a calendar entry;
in being programmed to identify within the parsed document content the plurality of individual items of information usable to create the augmented document content as specified by the reader-defined content creation profile, the processor is programmed to:
identify a conference call telephone number of a conference call within the parsed document content; and
identify a conference call passcode within the parsed document content; and
in being programmed to create the new item of augmented document content, as specified by the reader-defined content creation profile, using at least the portion of the identified plurality of individual items of information, the processor is programmed to:
create a reader-selectable clickable dial-in number for the conference call that causes programmatic dial-in and login to the conference call in response to reader selection of the reader-selectable clickable dial-in number.

10. The system of claim 9, where, in being programmed to create the reader-selectable clickable dial-in number for the conference call that causes programmatic dial-in and login to the conference call in response to reader selection of the reader-selectable clickable dial-in number, the processor is programmed to:
form a concatenated character sequence comprising the conference call telephone number, followed by a telephone dialing pause character, followed by the conference call passcode, and followed by a system-specific passcode entry designator; and
configure the reader-selectable clickable dial-in number using the concatenated character sequence.

11. The system of claim 10, further comprising a global positioning system (GPS) module, and where the processor is further programmed to:
determine a current location of the computing device using the GPS module;
determine, based upon the current location of the computing device, that telephone system access to the conference call telephone number utilizes an international calling code; and
where, in being programmed to form the concatenated character sequence, the processor is programmed to:
prefix the international calling code to the concatenated character sequence comprising the conference call telephone number, followed by the telephone dialing pause character, followed by the conference call passcode, and followed by the system-specific participant access code entry designator.

12. The system of claim 8, where, in response to detection of a hypertext link within the document content, the reader-defined content creation profile specifies creation of a summarized content entry using accessible content of the hypertext link, and the processor is further programmed to:
identify the hypertext link within the parsed document content;
navigate the hypertext link; and
retrieve content of a document accessed by navigating the hypertext link; and
where:
in being programmed to create the new item of augmented document content, as specified by the reader-defined content creation profile, using at least the portion of the identified plurality of individual items of information, the processor is programmed to:
parse the content of the document accessed by navigating the hypertext link; and
create the summarized content entry comprising a summary of the retrieved content as specified by the reader-defined content creation profile.

13. The system of claim 8, where the reader-defined content creation profile comprises a plurality of reader-defined device-specific content creation rules, each of the plurality of reader-defined device-specific content creation rules configured to create new items of augmented document content differently based upon a usable display area of each of a plurality of different devices utilized by the reader and a content type selected from a group consisting of a calendar entry content type, an email content type, a medical record content type, a social network entry content type, a notification content type, an instant message content type, a message content type, a news feed content type, a received data content type, and the processor is further programmed to:
determine an identifier of the computing device; and
select a reader-defined device-specific content creation rule from the reader-defined content creation profile based upon the identifier of the computing device; and
where, in being programmed to create the new item of augmented document content, as specified by the reader-defined content creation profile, using at least the portion of the identified plurality of individual items of information, the processor is programmed to:
create the new item of augmented document content, as specified by the selected reader-defined device-specific content creation rule, using at least the portion of the identified plurality of individual items of information.

14. A computer program product, comprising:
a computer readable storage medium having computer readable program code embodied therewith, where the computer readable program code when executed on a computer causes the computer to:
parse document content using a reader-defined content creation profile, where the document content comprises information and information layout specified by an author of the document content, and the reader-defined content creation profile specifies document content creation preferences specified by a reader and applicable to augment the document content;
identify within the parsed document content a plurality of individual items of information usable to create augmented document content as specified by the reader-defined content creation profile;
create a new item of augmented document content, as specified by the reader-defined content creation profile, using at least a portion of the identified plurality of individual items of information; and
render at least the created new item of augmented document content at a display location specified by the reader-defined content creation profile.

15. The computer program product of claim 14, where:
the document content comprises a calendar entry;
in causing the computer to identify within the parsed document content the plurality of individual items of information usable to create the augmented document content as specified by the reader-defined content creation profile, the computer readable program code when executed on the computer causes the computer to:
identify a conference call telephone number of a conference call within the parsed document content; and
identify a conference call passcode within the parsed document content; and
in causing the computer to create the new item of augmented document content, as specified by the reader-defined content creation profile, using at least the portion of the identified plurality of individual items of information, the computer readable program code when executed on the computer causes the computer to:
create a reader-selectable clickable dial-in number for the conference call that causes programmatic dial-in and login to the conference call in response to reader selection of the reader-selectable clickable dial-in number.

16. The computer program product of claim 15, where, in causing the computer to create the reader-selectable clickable dial-in number for the conference call that causes programmatic dial-in and login to the conference call in response to reader selection of the reader-selectable clickable dial-in number, the computer readable program code when executed on the computer causes the computer to:
form a concatenated character sequence comprising the conference call telephone number, followed by a telephone dialing pause character, followed by the conference call passcode, and followed by a system-specific passcode entry designator; and
configure the reader-selectable clickable dial-in number using the concatenated character sequence.

17. The computer program product of claim 16, where the computer readable program code when executed on the computer further causes the computer to:
determine a current location of the computing device using a global positioning system (GPS) module;
determine, based upon the current location of the computing device, that telephone system access to the conference call telephone number utilizes an international calling code; and
where, in causing the computer to form the concatenated character sequence, the computer readable program code when executed on the computer causes the computer to:
prefix the international calling code to the concatenated character sequence comprising the conference call telephone number, followed by the telephone dialing pause character, followed by the conference call passcode, and followed by the system-specific participant access code entry designator.

18. The computer program product of claim 14, where, in response to detection of a hypertext link within the document content, the reader-defined content creation profile specifies creation of a summarized content entry using accessible content of the hypertext link, and the computer readable program code when executed on the computer further causes the computer to:
identify the hypertext link within the parsed document content;
navigate the hypertext link; and
retrieve content of a document accessed by navigating the hypertext link; and
where:
in causing the computer to create the new item of augmented document content, as specified by the reader-defined content creation profile, using at least the portion of the identified plurality of individual items of information, the computer readable program code when executed on the computer causes the computer to:
parse the content of the document accessed by navigating the hypertext link; and
create the summarized content entry comprising a summary of the retrieved content as specified by the reader-defined content creation profile.

19. The computer program product of claim 14, where the reader-defined content creation profile comprises a plurality of reader-defined device-specific content creation rules, each of the plurality of reader-defined device-specific content creation rules configured to create new items of augmented document content differently based upon a usable display area of each of a plurality of different devices utilized by the reader, and the computer readable program code when executed on the computer further causes the computer to:
determine an identifier of the computing device; and
select a reader-defined device-specific content creation rule from the reader-defined content creation profile based upon the identifier of the computing device; and
where, in causing the computer to create the new item of augmented document content, as specified by the reader-defined content creation profile, using at least the portion of the identified plurality of individual items of information, the computer readable program code when executed on the computer causes the computer to:
create the new item of augmented document content, as specified by the selected reader-defined device-specific content creation rule, using at least the portion of the identified plurality of individual items of information.

20. The computer program product of claim 14, where the reader-defined content creation profile comprises a plurality of reader-defined device-specific content creation rules, each of the plurality of reader-defined device-specific content creation rules configured to create new items of augmented document content differently based upon a content type selected from a group consisting of a calendar entry content type, an email content type, a medical record content type, a social network entry content type, a notification content type, an instant message content type, a message content type, a news feed content type, and a received data content type.
